(19) United States
(12) Patent Application Publication
(10) Pub. No.: US 2022/0187172 A1
(43) Pub. Date: Jun. 16, 2022

(54) Device for gravimetric dilution of a sample with a predetermined quantity of liquid and corresponding method

(71) Applicant: ALLIANCE BIO EXPERTISE, GUIPRY-MESSAC (FR)

(72) Inventor: Philippe Le Saux, GUICHEN (FR)

(21) Appl. No.: 17/550,693

(22) Filed: Dec. 14, 2021

(30) Foreign Application Priority Data
Dec. 15, 2020 (FR) 2013223

(51) Int. Cl. G01N 1/20; G01G 17/06

(52) U.S. Cl. CPC G01N 1/2035; G01G 17/06

(57) ABSTRACT

A device for gravimetric dilution of a sample in a container with a predetermined quantity of liquid. The device includes a support for receiving the container defining a volume able to receive the container in an open position and an injector configured to inject the liquid into the container when the container is received by the support. The injector has an injection axis. The injector and the support are configured in such a way that during an injection of the liquid in the container, the injection axis is directed towards a chosen side edge of the container, in such a way that the liquid is spilt substantially over the side edge of the container.

### TECHNICAL FIELD

The invention relates to the field of instrumentation for biology or microbiology laboratories. More particularly, the invention relates to a device for gravimetric dilution of a sample with a suitable quantity of liquid. This type of device, commonly called “gravimetric dilutor” is used in particular, but not exclusively, in biological analysis laboratories of certain agro-food, cosmetics, medical, chemical or pharmaceutical industries.

### PRIOR ART

In the last few years, the agro-food sector has experienced a certain number of health crises. Professionals in the sector are now aware of the risks linked to pathogenic microorganisms on human and animal health. In order to anticipate any health problem, laboratories in the agro-food industries have acquired devices to conduct microbiological analyses to control the quality of the agro-food products before they are made available on the market.

To proceed with a microbiological analysis of a sample, it is suitable to prepare this sample beforehand. This preparation phase consists firstly in collecting various samples on the product concerned, then for each sample collected, in having it undergo a dilution in a sterile sachet with an adapted liquid. Once the dilution is carried out, the solution obtained is crushed, incubated and filtered before being subjected to the microbiological analysis strictly speaking. For the step of dilution, laboratories generally have recourse to gravimetric dilutors, which are sometimes housed under a microbiological safety enclosure (typically a “BSC” enclosure).

As shown in FIG. 1, a gravimetric dilutor 1 conventionally comprises a base 2 that houses means for weighing (also called “balance”), a member for injecting 4 a dilution liquid into an adapted bag 5 and a bag support 3 connected to the means for weighing. The bag support or rack 3, has a general U shape having two side walls 3a, 3b and a bottom wall 3c connecting the two side walls. The bottom and side walls define a volume able to receive the bag 5. The free ends of the side walls 3a and 3b (located on the side opposite the bottom wall) are shaped to be brought close to one another via elastic deformation (carried out via manual clamping) and maintain the sachet in the open position (after releasing of the side walls). In order to facilitate the putting and the maintaining in the open position of the bag 5, the free ends of the rack 3 are coated with an adhesive material intended for having the edges of the bag 5 adhere at its filling opening. The sampling bags used in the laboratory are generally made from a flexible and sterile polymeric material, able to contain a liquid and/or solid solution of variable mass.

The gravimetric dilution operation is typically carried out in the following way. The operator places the bag 5 vertically in the vertical median plane of the rack 3, the filling opening in the top position. After clamping of the free ends of the rack 3 in order to have the walls of the bag adhere to the adhesive material, the operator releases the free ends of the rack 3 so that they return to their idle position, thus maintaining the bag 5 open. A solid sample is then poured into the bag 5 via the filling opening. The dilutor carries out a weighing and distributes a precise quantity of liquid which is calculated according to the mass of the sample introduced into the bag. The balance carries out, automatically, a continuous weighing of the mass of the solutions contained in the bag and controls the stopping of the distribution when the mass of solution desired is reached. The bag is then closed, and subjected to crushing and is left at rest for a certain period at a temperature that favours the development of bacteria.

The surface of the side walls of the rack defines the dimensions of the bag that can be received in the rack of the dilutor. To increase the volume of a bag that can be received in the rack, it is common to increase the surface of the side walls of the rack. However, increasing the surface of the side walls of the rack makes the manipulations carried out by the operator awkward, in particular when the latter are carried out in a controlled atmosphere. Indeed, in this case, the rack is placed on the base of the dilutor which itself is housed under a standardised biological safety enclosure. This enclosure is provided with a central opening that authorises the passage of the arms of the operator to access the device. However, in order to prevent contaminating products from exiting, such an opening has a limited height that is standardised, sometimes causing the operator to have to twist in order to carry out their manipulations. Increasing the dimensions of the rack can therefore make the dilution manipulations very tedious.

Moreover, certain studies show that the preparation of samples represents in general about 60% of the working time of a laboratory technician in the analysis process. So, in order to increase productivity, a solution would consist in reducing the distribution time of the diluent, in other words in increasing the distribution speed of the dilutor. However, due to the particular configuration of conventional dilutors, this solution is limited by the risk of splashes. Indeed, the higher the speed of the incident liquid coming into contact with the wall of the bag is (which is thrust against one of the side walls of the carrier), the greater the quantity of splashes outside the bag is. In other terms, increasing the distribution speed would revert to increasing the risk of accidental flow of liquid outside the bag, which would cause a lack of hygiene and more substantial cleaning, and therefore a waste of time in the end.

There is therefore a real need to propose a device for gravimetric dilution that is more ergonomic and faster in terms of distribution of liquid, in order to make the sample preparation phase more productive.

### SUMMARY OF THE INVENTION

In a particular embodiment of the invention, a device for gravimetric dilution of a sample in a container with a predetermined quantity of liquid is proposed, the container comprising two walls assembled by opposite side edges, a bottom and a filling opening, said device comprising:
means for receiving the container defining a volume able to receive the container in an open position;
means for injecting configured to inject the liquid into the container when the container is received by the means for receiving, the means for injecting having an injection axis directed towards the filling opening.
   Such a device is characterised in that the means for injecting are arranged with respect to the means for receiving in such a way that during an injection of the liquid in the container, said injection axis is directed towards one of the side edges of the container in such a way that the liquid is spilt substantially over said side edge of the container.

Thus, the present invention is based on a new approach making it possible to optimise the gravimetric distribution operations. Indeed, thanks to this particular arrangement of the means for injecting in relation to the means for receiving, when a quantity of liquid is poured into the container, the splashes outside the container are reduced. Thus, contrary to conventional dilutors, the injection axis is always directed towards a side edge of the container, which makes it possible to increase the distribution speed of the liquid, and this regardless of the orientation of the container, without however losing in weighing precision. Moreover, such a device is more convenient to use due to the reduced risk of accidental splashes of liquid outside the container.

According to an aspect particulier of the invention, the means for injecting are configured movable in rotation with respect to a support member.

Thus the liquid injected thanks to the means for injecting can be directed on the desired portion of the container. Such a characteristic is particularly interesting on two points. On the one hand, making the means for injecting movable makes it possible to offer flexibility in choosing the direction of orientation of the container placed on the means for receiving: the means for receiving the device can indeed be configured so that the container is positioned either parallel to the operator, or perpendicular to the latter while still complying with the general principle hereinabove (injection axis is directed towards one of the two side fold zones of the container). On the other hand, this provides the operator with the possibility, for any manipulation that does not require distribution of liquid (preparation of samples, introduction and/or withdrawal of the container typically), to direct the injection axis in a direction other than those aiming the means for receiving (and therefore the container when the latter is present). It is thus possible to gain in working space and therefore render the manipulations easier. In addition, moving the means for injecting away from the opening of the container makes it possible to ensure a certain protection of the means for injecting against manual contaminations, and to reduce the risk of inter-sample contaminations.

According to a particular embodiment, the device being intended for being housed under a protective enclosure provided with an access window defining a window plane, then the means for receiving define a receiving plane, wherein the side edges of the container are intended substantially to be located, in such a way that the receiving plane is perpendicular to the window plane.

Thus, once the container is disposed in the receiving plane, the container is positioned perpendicularly to the operator, which greatly facilitates access to the device as well as to the container. The manipulations concerning weighing and dilution are made easier because the working space offered on either side of the container offers greater freedom of movement for the manipulations and/or the positioning of tools under protective enclosure, and in particular under standardised protective enclosure. This configuration is all the more so interesting in that it furthermore offers the possibility of using containers of different sizes without however reducing the useful working space in preparing the sample.

According to a particular configuration, the access window is a front access window.

Thus, the invention makes it possible to use a standard enclosure provided with a front window, the latter being substantially perpendicular to the side walls of the container. As an alternative, rather than a front access window, the enclosure is provided with a side access window, allowing for side access to the device. In this particular configuration, the means for receiving are then configured so that the receiving plane is perpendicular to the window plane.

According to a particular embodiment of the invention, the means for receiving comprise a receptacle able to support the container and an opening clamp able to maintain the container in the open position.

Such a receptacle can have the form of a plateau of which the dimensions make it possible to at least partially cover the base of the device. In this way, when liquid (or a portion of the sample) is poured outside the container, it can be collected by the receptacle preventing dirtying the device, thus protecting the base. For example, it can be shaped in such a way as to entirely cover the upper face of the base of the device. The receptacle can be configured to be removable in such a way as to facilitate the cleaning of the device.

According to a particular aspect, the opening clamp is engaged with the receptacle, for example one of the side walls of the latter, thus forming single-block means for receiving. Thus, rendering the means for receiving removable not only makes it possible to facilitate the cleaning of the device, but also the setting in place of the container when this is carried out outside the enclosure.

Alternatively, the opening clamp is not engaged with the receptacle but is engaged with the base of the device.

According to an alternative embodiment, the means for receiving comprise a rack able to receive the container and a receptacle able to receive said rack, said rack being formed from two side walls and from a bottom wall connecting the two side walls, said vertical walls being shaped to maintain the container in the open position.

Thus, the device according to the invention offers the possibility of using conventional racks.

According to a particularly interesting characteristic from a practicality standpoint, the device comprises a removable transport basket shaped to transport the container, said basket being intended for being placed on a bottom wall of the receptacle. The rack can be removable and can be separated from the basket.

Transport of the container is thus facilitated as well as well as the positioning thereof on the receptacle of the device. In the case where a rack is used, the basket is shaped to transport the rack, which receives the container.

According to a particular characteristic, the device comprises a telescopic mast at the end of which is fastened a head-up display and means for controlling said telescopic mast configured to modify the position of the head-up display according to a vertical axis, said head-up display being mechanically connected to the means for injecting via the support member.

This offers the possibility of adjusting the head-up display, and therefore the means for injecting, according to the height of the bag used, and thus gain in ergonomics. According to another particular aspect of the invention, the device comprises a removable injection pump, which is connected to the means for injecting and able to be placed outside the enclosure. Thus, contrary to the prior art, the volume usually taken by the injection pump within the enclosure is released to gain in working space. In other terms, the system gains in compactness under enclosure.

In another particular embodiment of the invention, a method for the gravimetric dilution of a sample in a container with a predetermined quantity of liquid using a dilution device is proposed, the container comprising two walls assembled by opposite side edges, a bottom and a filling opening, the method comprising the following steps:
disposing the container in an open position via means for receiving;
pouring said sample into the container through the filling opening;
injecting the liquid into the container via means for injecting, said means for injecting having an injection axis directed towards the filling opening.
   The method is characterised in that it comprises a step, carried out prior to the step of injecting, consisting of directing the injection axis of said means for injecting to one of the side edges of the container in such a way that the means for injecting inject the liquid substantially on said side edge of the container.

It is thus possible to increase the distribution speed of the liquid in the container.

### FIGURES

Other characteristics and advantages of the invention shall appear more clearly when reading the following description of a preferred embodiment, given as a simple non-limiting example for the purpose of illustration, and of the accompanying drawings, among which:

FIG. 1, already discussed hereinabove, diagrammatically shows a device for gravimetric dilution of the prior art;

FIG. 2 is a perspective view of a device for gravimetric dilution according to a first particular embodiment of the invention;

FIG. 3 is a perspective view of the device shown in FIG. 2, when the latter is housed under a protective enclosure;

FIG. 4 is a front view of the device shown in FIG. 3;

FIG. 5 is a perspective view of a device for gravimetric dilution according to a second embodiment of the invention;

FIG. 6 is a side view of the device shown in FIG. 5;

FIG. 7 shows an alternative of the means for receiving equipping the device in accordance with the first embodiment;

FIG. 8 is a top view of the device in its first embodiment of the invention;

FIG. 9 is a top view of the device in its second embodiment of the invention;

FIG. 10 shows a particular embodiment of the method according to the invention

FIG. 11 shows an example of the use of a transport basket in the first embodiment of the invention.

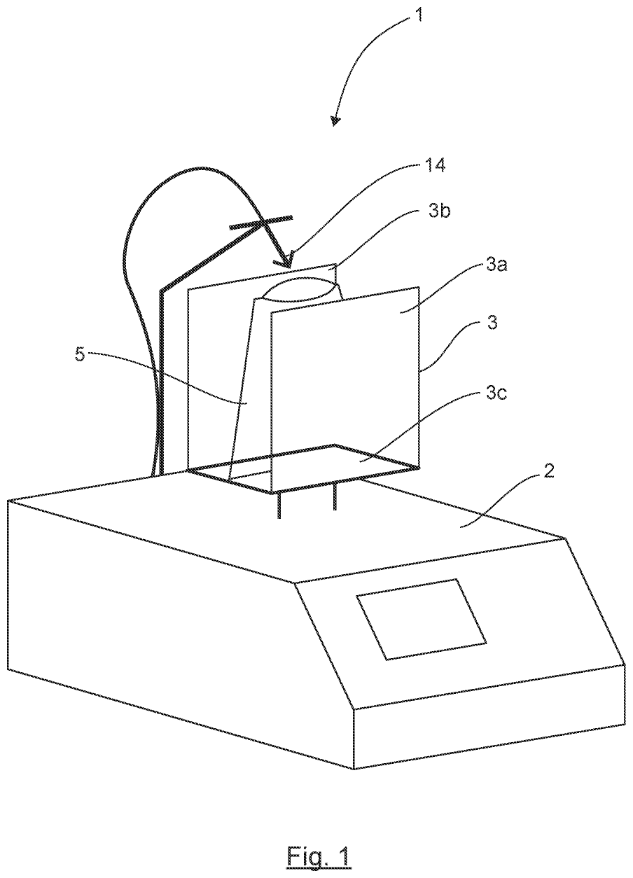

### DETAILED DESCRIPTION OF THE INVENTION

In the figures of the present document, identical elements are designated by the same numerical reference.

The general principle of the invention is based on a particular arrangement of the means for injecting liquid and means for supporting the sampling bag of the device in order to allow, on the one hand, an optimised distribution of the liquid in the bag, and on the other hand a facility of use, so as to gain in productivity during the preparation phase of the samples in the laboratory.

More particular attention is given in the rest of this document in describing the invention in the framework of a microbiological quality control of a solid sample coming from and agri-food product. Indeed, food safety, of which the microbiological quality of food is an essential component, represents a considerable stake for the agri-food industry. The invention is of course not limited to this particular field of application, but relates to any sector or any application that requires preparing a sample via gravimetric dilution.

Two particular configurations of the device are proposed: a so-called “portrait mode” configuration that allows for a disposition of the bag that is substantially perpendicular to the operator and a so-called “landscape mode” configuration that allows for a disposition of the bag that is substantially parallel to the operator. The second configuration is described hereinafter in relation with FIGS. 5, 6 and 9.

In order to better apprehend the concept of the present invention, the device of the invention (in any of its embodiments) is represented in a system of reference X, Y, Z. For better legibility of the figures, the different planes and axes are represented as dotted lines.

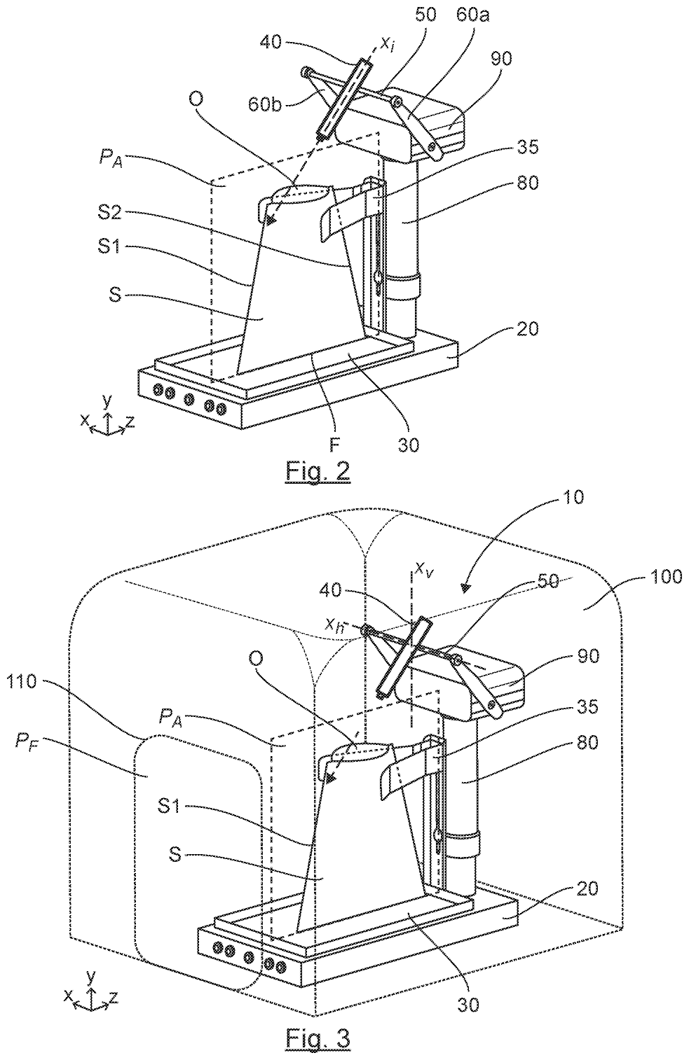

In relation with FIGS. 2, 3 and 4, a device for gravimetric dilution 10 according to a first embodiment of the invention is now presented. To simplify, the device according to the invention is in what follows called “dilutor”.

The dilutor 10 according to the invention comprises:
a base 20 that houses means for weighing and different electronic and/or mechanical components (not shown);
means for receiving 30 and 35 intended for receiving the container S in the open position;
means for injecting 40 configured to inject a dilution liquid into the container S according to an injection axis Xi for the purpose of diluting the sample.

In the example shown here, the container S is a sterile sampling bag, made from a flexible and sealed material, for example a film made of plastic material such as polyethylene. The bag S typically comprises two walls—a front wall and a rear wall—assembled by opposite side edges S1 and S2, a bottom F and a filling opening O.

The means for weighing form the balance of the dilutor: they are configured to make it possible to weigh, continuously and automatically, the container poured into the bag S (sample, dilution liquid).

The means for receiving of the dilutor 10 are configured to define a volume able to receive the bag S in an open position making it possible to receive the liquid. The means for receiving comprise, in this first embodiment, a support 30 able to support the bag S and an opening clamp 35 able to open the bag S and to maintain it in an open position (i.e. with the opening O oriented upwards). The clamp 35 comprises two elastically flexible and substantially parallel arms that extend horizontally in the direction of the operator (along the axis Z) from a vertical bar. The ends of the two arms are coated with an adhesive material intended for having the edges of the bag S adhere at its opening O, facilitating the maintaining of the bag Sin the open position. The clamp 35 is configured to be movable in translation with respect to the vertical bar in such a way as to be able to adjust the height of the clamp with respect to the height of the bag S placed on the support 30. The dimensions of the clamp are adapted to the dimensions of the bag used. Regarding the support 30, it is shaped in the shape of a plateau to be used as a receptacle able to possibly recover the liquid flowing outside the bag S or in the absence of a bag (in case of accidental flow for example). In order to ensure this function of the receptacle, the support 30 extends at least over the upper face of the base 20. Preferably, the contour of the support 30 rather largely surrounds the entire periphery of the base 20 of the device. On the other hand, the support 30 is mechanically connected to a sensitive member of the means for weighing configured to transmit the weighing force measured by the dilutor 10. In the example shown here, the support 30 and the opening clamp 35 are engaged with one another, and form removable means for receiving of a single piece, in particular to facilitate the cleaning of the device 10. According to an alternative, the opening clamp 35 is engaged with the base 20 of the device.

The means for injecting 40 of the dilutor 10 are configured to inject the dilution liquid into the bag S when the container S is placed on the support 30. The means for injecting 40 have an injection axis Xi directed towards the opening O of the bag. In the present example, the means for injecting 40 are comprised of an injection nozzle and of a system for attaching and adjusting the latter. Means for conveying (not shown) connected on the one hand to the injection nozzle and on the other hand to the injection pump (not shown) make it possible to convey the dilution liquid from the pump to the injection nozzle.

The means for injecting 40 according to the invention are arranged with respect to the means for receiving 30 and 35 in such a way that during an injection of liquid into the bag S, the injection axis Xi is directed towards the side edge S1 of the bag S in such a way that the liquid is spilt substantially over this side edge of the bag S. This portion of the bag S is broadly flexible because it is in contact with no element of the receiving means. Thus, in the present configuration in portrait mode, the means for injecting are oriented in such a way that the injection axis Xi extends substantially along axes Y and Z.

Thus, when a quantity of liquid is poured into the bag S, the splashes outside the bag S are reduced, contrary to conventional dilutors where the injection axis is directed towards one of the front or rear walls of the bag. This clever approach thus offers the possibility of increasing the distribution speed of the liquid while still limiting the risk of splashes outside the container (and thus gain in productivity).

FIGS. 2 and 3 show the operating principle of the dilutor 10 when it is housed in a standard protective enclosure 100, for example a standardised microbiological safety enclosure of “BSC” type. The dilutor 10 and the enclosure 100 then form a secure system for gravimetric dilution according to the invention. Such an enclosure 100 is provided with a front window (or opening) 110 authorising access of the arms of the operator in the enclosure 100 substantially along the axis Z. Such a window (or opening) 110 has a height and a limited width (for example a height of 18 cm and a width of 120 cm in order to prevent contaminating products from exiting.

The following are considered in what follows:
the plane P_{A}, the plane of the means for receiving 30 and 35 corresponding to the vertical median plane passing substantially through the side edges S1 and S2 of the bag S (when the bag S is placed in the open position on the support 30 and between the arms of the clamp 35);
the plane P_{F}, the plane of the access window 110.

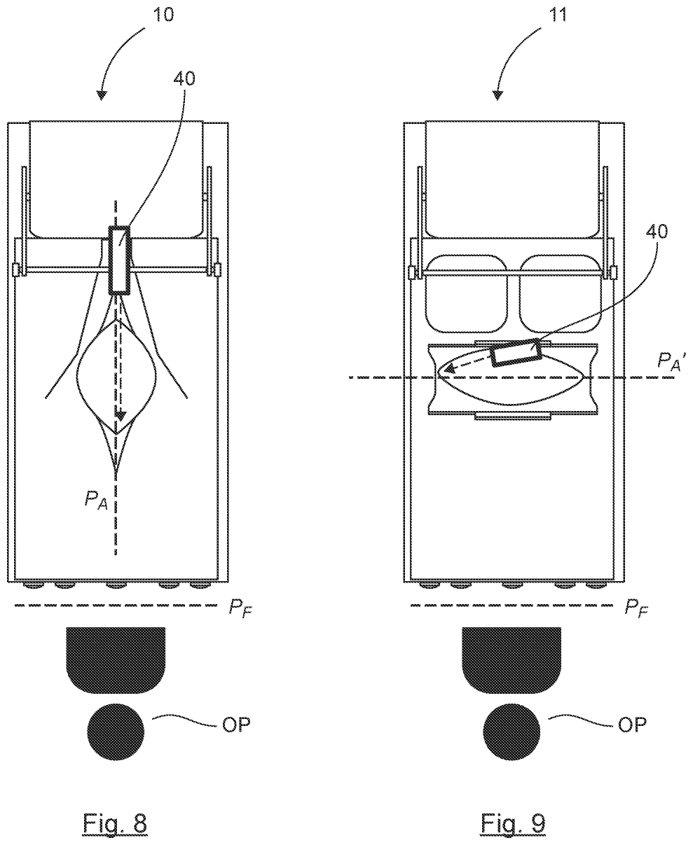

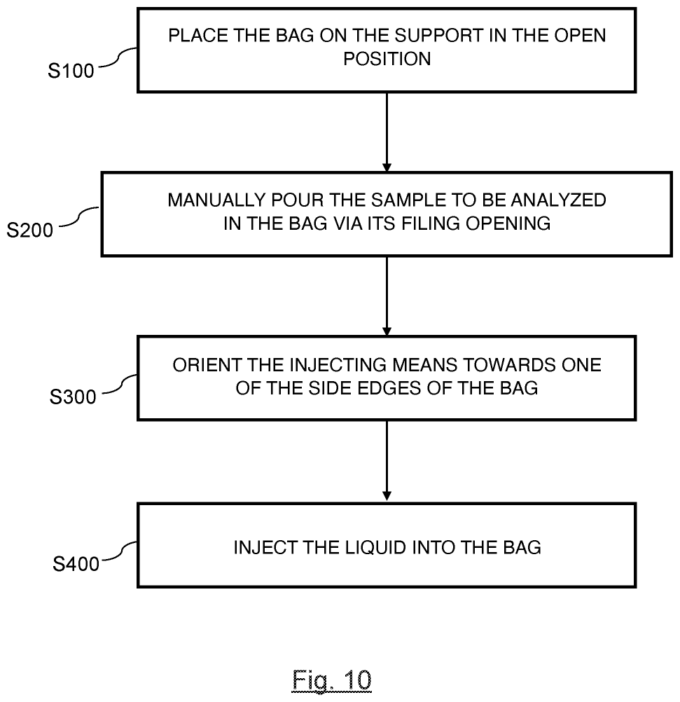

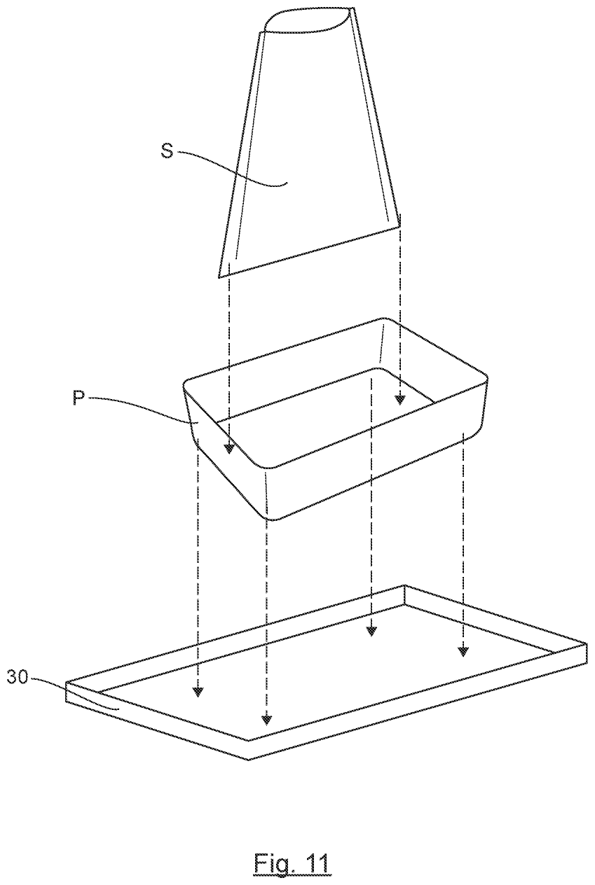

In this first embodiment, the means for receiving of the dilutor 10 are configured in such a way that the receiving plane P_{A} is perpendicular to the window plane P_{F}. Thus, once placed on the support 30 and between the arms of the clamp 35, the bag S (and more precisely the axis of the bag passing through its two side edges) is positioned (in the open position) perpendicularly to the access window 110 and therefore to the operator, as shown in FIG. 8. Such a configuration thus allows for a greater facility in manipulation within the enclosure 100 (contrary to the dilutor of the prior art). The weighing and dilution manipulations are made easier because the working space offered on either side of the receiving plane P_{A} offers greater freedom of movement and allows for the possible positioning of tools. Note that this configuration is all the more so interesting in that it furthermore offers the possibility of using bags of different formats while still maintaining a working space that is suitable for manipulations under a controlled atmosphere. This is the case with bags of the “large format” type intended for containing samples with a mass typically comprised between 100 and 550 g, in comparison with bags of more reduced volumes, of the “small format” type, intended for containing samples with a mass comprised between 10 to 50 g typically. Thus, the dilutor 10 according to the invention is therefore easier to use, in particular under standard standardised enclosure.

According to another aspect of the invention, the dilutor 10 is furthermore equipped with a telescopic mast 80 at the end of which is fastened a head-up display 90, and means for controlling the telescopic mast configured to modify the position of the head-up display 90 according to the vertical axis defined by the telescopic mast 80. This offers the possibility to adjust the head-up display 90 according to the height of the bag used, and thus gain in ergonomics. The dilutor 10 is also provided with a removable injection pump (not shown) connected to the means for injecting via means for conveying, said pump being placed outside the enclosure 100. Thus, contrary to the prior art, the volume usually taken by the injection pump within the enclosure is released in order to gain in working space. The device under enclosure therefore gains in compactness. In addition, this makes it possible to reduce exposure of the weighing system to the inherent mechanical vibrations of the pump.

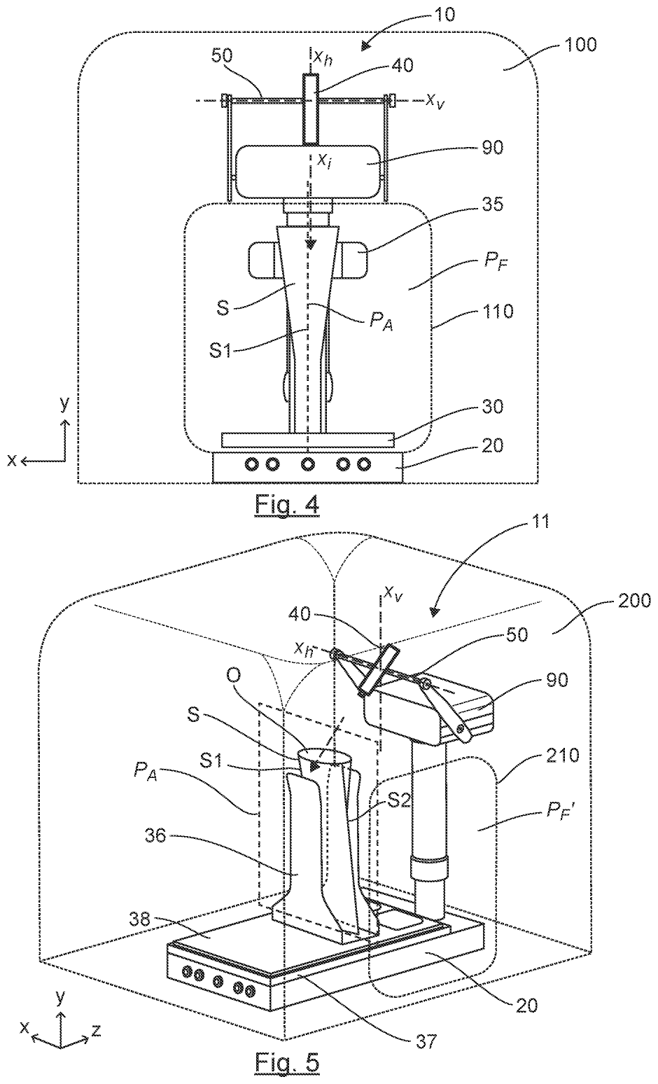

According to another aspect of the invention, the means for injecting 40 are configured movable in rotation with respect to the support member 50 according to at least two orthogonal axes: a first horizontal axis Xh extending along the axis X (confounded with the support member 50 and s′) and a second substantially vertical axis Xv extending along the axis Y, as shown in FIGS. 3 and 4. Thus, the liquid injected thanks to the means for injecting can be directed onto the desired part of the bag S. Such a characteristic is particularly interesting on two points. On the first hand, rendering the means for injecting mobile makes it possible to offer flexibility in the choice of the configuration of the device (orientation bag S perpendicularly or parallel to the operator) while still complying with the general principle of the invention (namely that the injection axis Xi is oriented in the direction of a side edge of the bag S). On the other hand, this gives the possibility of orienting the means for injecting 40 in a direction that does not hinder the manipulations outside injection (introduction of the bag, removal of the bag, manual filling of the bag with the sample, etc.). Indeed, in the injection position, the injection nozzle is located at a point that is located substantially above the bag at a non-zero distance from the opening O of the bag. Thus, moving the injection nozzle from the opening O of the bag S makes it possible on the one hand to gain more in working space under enclosure, and on the other hand to reduce the risk of inter-sample contaminations. Moreover, the means for injecting 40 can cooperate with means for orientating the nozzle able to orientate said nozzle according to at least two orthogonal axes, such as for example means for orienting comprising a double pivot connection or a spherical connection of the ball type, without being complete. It is possible to consider, without leaving the scope of the invention, that these means for orientation cooperate with means for controlling in order to allow for an automatic adjustment of the axis Xi of the means for injecting 40.

On each end of the support member 50 is fastened a porting arm, each porting arm 60a and 60b being itself fastened movable in rotation about an axis on a side face of the head-up display 90, authorising a tipping of the means for injecting 40 from an injection position (the injection nozzle 40 is then disposed substantially towards the front of the head-up 90 as shown in the figures with the nozzle located substantially above the bag) at an idle position (the injection nozzle 40 is then disposed substantially towards the rear of the head-up 90, i.e. outside the working space).

A passage for cables can be provided on one of the side faces of the protective enclosure, for example, on the rear side face for more convenience, so as to allow for the passage of electric cables and/or means for conveying the dilution liquid. Otherwise, the means for conveying can be disposed in such a way as to pass through the access window so as to authorise the presence of the injection pump outside said enclosure.

In relation with FIGS. 5 and 6, a gravimetric dilutor 11 according to a second embodiment of the invention is now presented. The dilutor 11 is housed in a protective enclosure 200, for example a standardised microbiological safety enclosure. The device 11 and the protective enclosure 200 form a secure system for gravimetric dilution according to the invention. The configuration proposed in this second embodiment is particularly well adapted, but not exclusively, to the distribution of liquid in a small format bag.

This second embodiment differs mainly from the first embodiment in that the bag S is positioned parallel to the operator. This configuration in landscape mode is particular well illustrated in the top view of FIG. 9.

In this second embodiment, the means for receiving of the dilutor 11 comprise a rack of conventional shape, referenced as 36. Such a rack 36 is formed from two side walls and from a bottom wall connecting the two side walls, the whole defining a volume able to receive the bag S in an open position substantially in a plane P_{A}′. The plane P_{A}′ corresponding to the vertical median plane comprised between the two side walls of the rack 36. The vertical walls of the rack 36 are shaped to maintain the container in the open position: they are elastically flexible in such a way that they can be manually brought closer together to one another by elastic deformation and make it possible to maintain the bag S in the open position once the walls are released. Their free end is coated with an adhesive material intended for having the edges of the bag S adhere and thus facilitate the setting into the open position of the bag S and the maintaining thereof in this position. The dimensions of the rack 36 are adapted to the dimensions of the bag used.

In accordance with the general principle of the invention, the means for injecting 40 are arranged with respect to the rack 36 in such a way that during an injection of the liquid into the bag S, the injection axis Xi is directed towards the side edge S1 of the bag S in such a way that the liquid is spilt substantially over this said edge, thus reducing the risk of splashes and authorising a more substantial distribution speed of the liquid. In fact, the rack 36 is disposed on the support 37 in such a way that the receiving plane P_{A}′ is located along axes X and Y, and the axis Xi of the means for injecting oriented in the direction of the side edge S1, are substantially along axes X and Y (i.e. in the plane P_{A}′).

Therefore, when the liquid is injected, as the injection axis Xi is broadly arranged parallel to the side wall of rack 36, the liquid is spilt on a portion of bag S which is flexible (because said portion is not in contact with the rigid wall of rack 36. Such an astute arrangement allows reducing splashes during injection operation, contrary to the prior art where the injection axis Xi is arranged perpendicular to the side wall of rack, the liquid being spilt on a portion of bag S in contact with the rigid wall of rack.

In the present example, the enclosure 200 is provided with a side window (or opening) 210 authorising the access of the arms of the operator in the enclosure 200 along the axis of the bag S. Such a window (or opening) 210 has a height and a limited width in order to prevent any contaminating products from exiting. As shown in FIGS. 5, 6 and 9, the plane P_{F}′ of the side window 210 is perpendicular to the receiving plane P_{A}′. This enclosure with a side window has the advantage of greatly facilitating the manipulations of the operator because it allows for an access on either side of the front and rear walls of the bag S with a greater freedom of movement. Note however that the use of a standard protective enclosure, i.e. of an enclosure with a front window (such as the enclosure 100 shown in FIGS. 3 and 4), would constitute an alternative that is entirely considerable with this second embodiment without leaving the scope of the invention, although less optimal in terms of working space.

The dilutor 11 further comprises a receptacle 37 mechanically connected to the sensitive member of the means for weighing. The receptacle 37 extends at least on the upper face of the base 20 and can fulfil the same function as the support 30 of the dilutor 10. Optionally, in order to facilitate the setting in place of the rack 36 and ensure its maintaining, the dilutor 11 can also comprise a guide plate 38 extending at least partially on the upper face of the receptacle 37 and shaped to receive the lower portion of the rack 36.

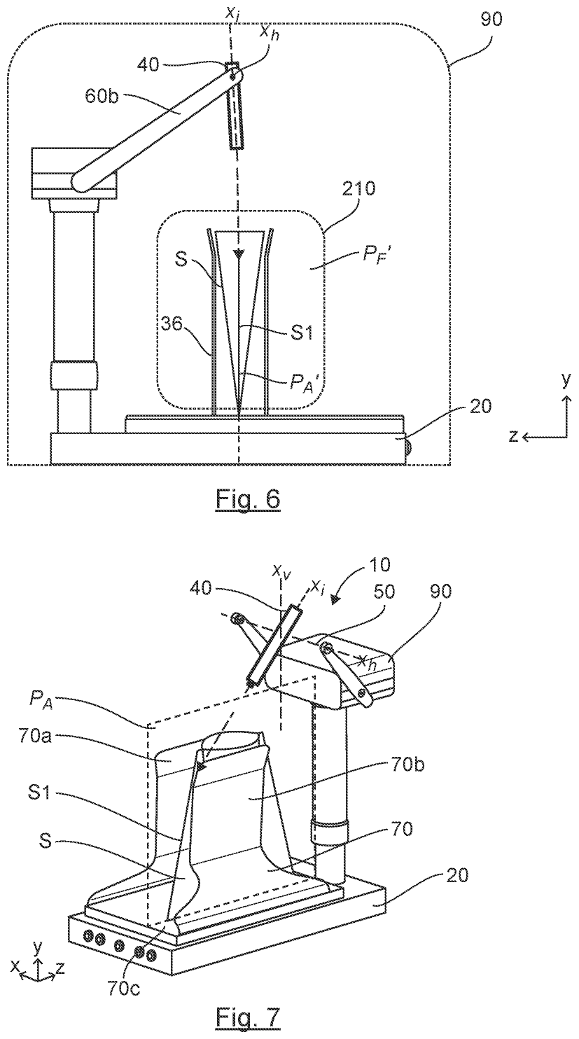

FIG. 7 shows an alternative of the means for receiving provided on the dilutor 10 (in accordance with the first embodiment of the invention). Unlike FIGS. 2 to 4, in this example, the means for receiving comprise a rack 70. This rack 70 is formed from two side walls 70a and 70b and from a bottom wall 70c connecting the two side walls, defining a volume able to receive the bag S in an open position substantially in the plane P_{A} (the P_{A} corresponding then to the vertical median plane comprised between the two side walls of the rack 70). The dimensions of the rack 70 are adapted to the dimensions of the sampling bag used. In the present example, the configuration of the dilutor 10 is particularly well adapted to the use of “large format” bags.

FIG. 8 is a top view of the dilutor 10 described hereinabove in relation with FIGS. 2, 3, 4, while FIG. 9 is a top view of the dilutor 11 described hereinabove in relation with FIGS. 5 and 6. The plane P_{F} represents the plane of the front access window of a standard enclosure. The planes P_{A} and P_{A}′ represent the receiving planes of the sampling bag respectively the first and second embodiments of the device according to the invention. The operator OP is represented by a black icon. From this point of view, similar to the format of a photo or of an image, the dilutor 10 is configured according to a “portrait” mode (FIG. 8), the receiving plane P_{A} being perpendicular to the plane of the window P_{F}. Regarding the dilutor 11, it is configured according to a “landscape” mode (FIG. 9).

FIG. 9 shows, in the form of a flowchart, the method according to a particular embodiment of the invention. The method is implemented by means of the gravimetric dilutor 10 of which the principle is described hereinabove in relation with FIGS. 2, 3, 4.

In step S100, the operator places a sterile sampling bag, of the large format type, via the access window 110 of the protective enclosure 100, in the vertical median plane of the means for receiving of the dilutor 10. The operator then carried out via elastic deformation a clamping of the free ends of the clamp 35 in order to have the front and rear walls of the bag S adhere to the adhesive material, releases these free ends so that they return to their idle position, maintaining the sampling bag open. The sampling bag is disposed such that the filling opening O is positioned upwards and the axis of the bag S perpendicular to the plane of the window 110. Although the bag S has a certain volume in the enclosure 100, due to the clever configuration of the dilutor 10 of which the principle was described hereinabove, the setting in place of the bag S and its access is relatively easy despite its volume. As a precautionary measure and for convenience, the operator will tip the means for injecting 40 (via the elements 60a and 60b, 50) at the rear of the head-up display 90 in such a way as to move the means for injecting 40 away from the working space during the preparation of the dilution operation.

In step S200, the operator pours a solid sample of 375 g coming from an agri-food product into the bag S via the opening O. While the sample is poured into the bag S, the dilutor 10 carries out a continuous weighing of the bag S. The head-up display 90 displays in real time the mass contained in the bag S.

In step S300, once the sample is poured into the bag S, the operator tips all the means for injecting 40 at the front of the head-up display 90 and orients the injection nozzle 40 according to the axes Xv and Xh in such a way that the injection axis Xi is directed towards the desired portion of the bag S (the side edge S1 of the bag S here).

In step S400, the operator proceeds with the injection of a predetermined quantity of dilution liquid into the bag S according to the injection axis Xi. The quantity of liquid is calculated according to the mass of solid sample introduced into the bag S. For example, for 375 g of sample, a precise quantity of 0.3 L of liquid is poured into the bag S. The injection axis Xi being oriented in the direction of the side edge S1 of the bag S, the liquid injected by the means for injecting 40 is poured substantially on the side edge S1 of the bag S with a distribution speed of the liquid that can be comprised typically between 0.1 and 6.0 L/min.

Once the predetermined quantity of liquid is poured, the dilutor 10 instantaneously stops the distribution of liquid and the dilution operation ends. The operator can thus close the sampling bag and remove it from the enclosure 100 without any particular difficulty.

In relation with FIG. 11, an example of the use of a transport basket P in the framework of the first embodiment of the invention is now presented. This characteristic is particularly interesting in particular from a practicality standpoint, since it has for role to facilitate the transport of the bag S, before and after the dilution phase. Such a basket is comprised of a body comprising a bottom wall and four side walls.

In the framework of the first embodiment, the basket is shaped so as to be able to receive the bag alone.

In the framework of the second embodiment, the basket P is shaped in such a way as to be able to receive the rack, itself receiving the bag S. In other terms the basket P is configured to transport the container via the rack

The basket is dimensioned according to the dimensions of the bag to be transported, but also according to the dimensions of the window of the enclosure wherein the dilutor is located (and in particular the height of the side walls of the latter) so as to retain a relatively comfortable working volume for the operator through the access window, while still allowing for easy transport of the bag outside the enclosure. As shown in the figure, the basket P being intended for being placed on the bottom wall of the receptacle 30, the receptacle 30 and the basket P are therefore shaped so that the bottom wall of the receptacle 30 defines a surface able to receive the bottom wall of the basket P.

1. A device for gravimetric dilution of a sample in a container with a predetermined quantity of liquid, the container comprising first and second walls assembled by opposite side edges, a bottom and a filling opening, said device comprising:
a support configured to receive the container defining a volume able to receive the container in an open position;
an injector configured to inject the liquid into the container when the container is received by the support, the injector having an injection axis directed towards the filling opening;
wherein the injector is arranged with respect to support in such a way that, during an injection of the liquid in the container, said injection axis is directed towards one of the first or second side edges of the container in such a way that the liquid is spilt substantially over said first or second side edge of the container.

2. The device according to claim 1, wherein the injector is movable in rotation with respect to a support member according to at least two orthogonal axes.

3. The device according to claim 1, said device being is housed under a protective enclosure, said protective enclosure comprising an access window defining a window plane, and wherein said support defines a receiving plane wherein the receiving plane is perpendicular to the window plane.

4. The device according to claim 1, wherein said access window is a front access window.

5. The device according to claim 1, wherein the support comprises a receptacle able to support the container and an opening clamp able to maintain the container in the open position.

6. The device according to claim 5, wherein the opening clamp is engaged with the receptacle.

7. The device according to claim 1, wherein the support comprises a rack able to receive the container and a receptacle able to receive said rack, said rack being formed from first and second side walls and from a bottom wall connecting the first and second side walls of the rack, said first and second side walls of the rack being shaped to maintain the container in the open position.

8. The device according to claim 1, wherein the support comprises a rack able to receive the container and the device comprises a removable transport basket shaped to transport said container, said basket being positionable on a bottom wall of the receptacle.

9. The device according to claim 2, comprising a telescopic mast at an end of which is fastened a head-up display and a mast controller configured to control the telescopic mast to modify a position of the head-up display according to a vertical axis, said head-up display being mechanically connected to the injector via the support member.

10. A method for gravimetric dilution of a sample in a container with a predetermined quantity of liquid using a dilution device, the container comprising first and second walls assembled by opposite side edges, a bottom and a filling opening, the method comprising:
disposing the container in an open position via a support of the device;
pouring said sample into the container through the filling opening; and
injecting the liquid into the container via an injector, said injector having an injection axis directed towards the filling opening;
prior to injecting, directing the injection axis to one of the side edges of the container in such a way that the injector injects the liquid substantially on said side edge of the container.
